(19) United States
(12) Patent Application Publication
(10) Pub. No.: US 2015/0032323 A1
(43) Pub. Date: Jan. 29, 2015

(54) METHOD FOR THE AUTOMATIC GUIDANCE, IN PARTICULAR PARKING OF A MOTOR VEHICLE AND A DRIVER ASSISTANCE DEVICE

(71) Applicant: ROBERT BOSCH GMBH, Stuttgart (DE)

(72) Inventors: Klaus-Dieter Nijakowski, Heilbronn (DE); Christian Reiner, Ludwigsburg (DE); Thomas Feufel, Loechgau (DE)

(73) Assignee: Robert Bosch GmbH, Stuttgart (DE)

(21) Appl. No.: 14/378,754

(22) PCT Filed: Dec. 17, 2012
(86) PCT No.: PCT/EP2012/075733

§ 371 Date: Aug. 14, 2014

(30) Foreign Application Priority Data
Feb. 14, 2012 (DE) 10 2012 202 175.2

(51) Int. Cl. B60W 30/06; B60W 50/029

(52) U.S. Cl. CPC B60W 30/06; B60W 50/029
USPC 701/23

(57) ABSTRACT

In a method for the automatic guidance, e.g., parking, of a motor vehicle, which has a driving device for driving the motor vehicle, braking equipment for braking the motor vehicle, as well as a transmission device, in a normal operation, the braking equipment carrying out automatic braking during the automatic guidance, it is provided that, when a fault of the braking equipment occurs during the automatic guidance, an emergency operation is carried out, in which the motor vehicle is braked automatically to a standstill only by using the driving device and/or the transmission device.

### BACKGROUND OF THE INVENTION

1. Field of the Invention

The present invention relates to a method and a device for the automatic guidance of a motor vehicle, which has a driving device for driving the motor vehicle, braking equipment for braking the motor vehicle as well as a transmission device for driving the motor vehicle, in a normal operation, the braking equipment carrying out automatic braking during the automatic guidance.

2. Description of the Related Art

Methods of the type described at the outset are known from the related art. With its aid, the motor vehicle is able to be guided automatically, particularly fully automatically, especially brought into a parking position, for instance, on an identified parking area or in a parking space. During the automatic guidance, the motor vehicle is driven in the longitudinal direction with the aid of the driving device. The braking equipment is used correspondingly to decelerate the motor vehicle in the longitudinal direction. The transmission device is additionally provided, via which the driving device drives the motor vehicle or rather acts on at least one wheel of the motor vehicle. In normal operation, the deceleration of the motor vehicle, especially the deceleration all the way to a standstill, is carried out with the aid of the braking equipment. Thus, the braking equipment is actuated in such a way that the speed of the motor vehicle is reduced.

Braking is carried out automatically, that is, without driver intervention. For this purpose, for instance, in at least one wheel brake cylinder, which is assigned to one wheel of the motor vehicle, a brake pressure is built up that is directed to the deceleration of the motor vehicle, without a corresponding interaction with the driver taking place. To carry out the automatic braking, a driver assistance system of the motor vehicle, particularly an ESP driver assistance system, is used, for example. This enables both the automatic build-up of the brake pressure and its reduction. The method described is particularly suitable for driving situations and parking situations in which the driver is not located in the motor vehicle, but is rather operating it from the outside, using remote control. Now, if a fault of the braking equipment takes place, the driver is not able readily to operate manually the braking equipment for building up the brake pressure, for example, by operating a brake pedal.

### BRIEF SUMMARY OF THE INVENTION

The method according to the present invention has the advantage that the motor vehicle is able to be safely brought to a standstill, even in the case of a malfunction or fault of the braking equipment. According to the present invention, this is achieved in that, when a fault of the braking equipment occurs during the automatic guidance, an emergency operation is carried out, in which the motor vehicle is braked automatically to a standstill only by using the driving device and/or the transmission device. The fault in the braking equipment prevents it from automatically decelerating the motor vehicle. For example, the fault prevents the brake pressure from being built up automatically, that is, using a conveying device, particularly a return pump of the driver assistance system. The method is preferably carried out when the driver is not located in the motor vehicle, and is thus not able to operate the braking equipment manually to build up the brake pressure. Accordingly, it has to be ensured, even when faults occur, that the motor vehicle is able safely to be brought to a standstill.

The emergency operation is carried out for this purpose. In the emergency operation, the driving device is automatically set so that the motor vehicle is braked all the way to a standstill. That is, it is not only provided that the motor vehicle should be easily decelerated within the meaning of an “engine brake”. Rather, a complete standstill should be achieved only with the aid of the driving device. If the driving device is present, for instance, in the form of an internal combustion engine, it may, in particular, be “choked”, so that subsequently braking of the motor vehicle, conditioned by the moment of inertia of the driving device and/or its inner frictional forces takes place. The braking of the motor vehicle using the driving device should take place automatically, that is, not only after a manual interaction by the driver. In a particularly preferred manner, the braking is carried out immediately after the occurrence of the fault, so that the driver is subsequently able to take over the guidance and parking of the motor vehicle. For braking the motor vehicle with the aid of the driving device, an operative connection is produced between the driving device and the at least one wheel of the motor vehicle, via the transmission device and a clutch device that is usually additionally provided.

Alternatively, the braking of the motor vehicle is able to take place only with the aid of the transmission device or only with the aid of the driving device and the transmission device. Braking while using the transmission device is carried out particularly if the latter is present in the form of an automatic transmission device. Such a device may be brought into a park position in which an output shaft facing away from the driving device with regard to the transmission device is blocked or at least braked. Particularly advantageously it is obvious if the braking takes place by the simultaneously corresponding actuation of the driving device and the transmission device. Consequently, even in cases in which the moment of inertia and/or the internal frictional forces of the driving device are not sufficient for the complete braking of the motor vehicle, a safe deceleration of the motor vehicle all the way to a standstill is able to be achieved.

The automatic guidance or driving of the motor vehicle is preferably only carried out only at low vehicle speeds, that is, especially up to a vehicle speed which is clearly less than a maximum speed of the motor vehicle. For example, the vehicle speed of the motor vehicle, during automatic guidance, should at most amount to walking speed, that is, clearly less than 20 km/h, for example, between about 4 km/h and about 10 km/h. In principle, however, the vehicle speed may be selected optionally.

One refinement of the present invention provides that, in normal operation, the braking equipment brake the vehicle using an operating brake and/or a parking brake. The operating brake may be present in the form of an hydraulic brake, for example, and enables decelerating or braking the motor vehicle during a driving operation of the motor vehicle. The operating brake may usually be used both automatically and manually by the driver of the motor vehicle, particularly by operating a brake pedal, for braking the motor vehicle. Preferably, the operating brake acts as the hydraulic brake, for example, on all wheels of the motor vehicle. If it is developed as the hydraulic brake, then it has, for example, particularly one main brake cylinder and at least one wheel brake device, particularly one wheel brake cylinder, assigned to a wheel of the motor vehicle. In contrast to the operating brake, the parking brake is used to brake the motor vehicle durably during its standstill or to settle it in one place, to prevent it from moving away undesirably. The parking brake is preferably present in the form of an electrically operated parking brake, which acts upon at least one wheel of the motor vehicle.

A development of the present invention provides for the drive unit to be an internal combustion engine. The internal combustion engine is normally used only for driving the motor vehicle in the longitudinal direction, but not for braking it to a standstill. Such braking is normally undesired, because the rotational speed of the internal combustion engine has to attain at least a minimum rotational speed for a reliable operation of the internal combustion engine to be at all possible. If the rotational speed falls below the minimum rotational speed, the internal combustion engine is no longer able to give off any torque, along with which its rotational speed usually drops off further rapidly. This process is referred to as “choking”. Subsequently to the choking, if the internal combustion engine is operationally connected to the wheel, it acts on the motor vehicle in a braking manner. Such braking is correspondingly only used in emergency operation, but not in normal operation.

One refinement of the present invention provides that, for braking the motor vehicle in emergency operation, the internal combustion engine, especially the fuel supply and/or the ignition be shut down. That is, the internal combustion engine is set in such a way that it no longer gives off any torque to the wheel, but rather acts in a braking manner upon it. In this context, the braking is supposed to take place to a standstill, at which the rotational speed of the internal combustion engine has dropped off to zero. Shutting down the internal combustion engine may be achieved, for instance, by interrupting the fuel supply and deactivating the ignition.

One refinement of the present invention provides that an output shaft of the transmission device is braked or blocked in response to the occurrence of the fault. The output shaft is present on the side facing away from the driving device with respect to the transmission device, and is able to be operatively connected to the wheel and via the clutch device. For the purpose of braking the motor vehicle, the clutch device is set correspondingly to produce the operative connection. At the same time, the output shaft is braked or blocked in emergency operation. In particular, if the transmission device is present as an automatic transmission device, the blocking of the output shaft is usually possible by using a braking element that is cooperatively working with it in a form-locking manner, particularly a latching element.

One refinement of the present invention provides that the driving device, particularly a driving device control unit of the driving device monitors an operating state of the braking equipment, particularly of the braking equipment control unit of the braking equipment. That is, it is provided that the driving device is in communication connection with the braking equipment. In this context, the operating state of the braking equipment is particularly determined by the driving device. If the operating state indicates the fault of the braking equipment, a change is made from normal operation to emergency operation, and thereafter the automatic braking of the motor vehicle using the driving device or the transmission device is carried out. The braking equipment control unit is provided for actuating the individual elements of the braking equipment, that is particularly of the operating brake and/or the parking brake. If one of these two brakes demonstrates a fault, the driving device is notified of this in the form of an operating state, whereupon it is able to carry out the emergency operation. Alternatively, the driving device is also able to determine a fault in the braking equipment control unit itself, and react to it accordingly by initiating the emergency operation. The monitoring of the operating state is preferably carried out with the aid of the driving device control unit. Alternatively, of course, an additional control unit may also be used for this purpose. In principle, after determining the fault of the braking equipment, the driving device may also actuate the transmission device to carry out the automatic braking of the motor vehicle. For this purpose, there is a communication connection present in this instance too.

One refinement of the present invention provides that, during the automatic guidance, the braking equipment transmits the operating state to the driving device and/or the transmission device using a communication device. That is, the operating state is determined, and is subsequently provided to the internal combustion engine and the transmission device or transmitted to them. This is preferably carried out cyclically or at certain intervals. The internal combustion engine or the transmission device may detect the fault of the braking equipment, even if the latter no longer transmits or provides the operating state. The communication device is, for instance, a bus system of the motor vehicle, a CAN bus system, for example.

Another refinement of the present invention provides that, during the automatic guidance, a steering angle is automatically set using a steering device. In this respect, the guidance and the parking of the motor vehicle takes place automatically, because not only is a longitudinal guidance using the driving device and the braking equipment carried out in cooperation with the transmission device, but rather lateral guidance as well. The steering device sets the steering angle at at least one wheel of the motor vehicle, so that the wheel, and correspondingly also the motor vehicle, at a speed different from zero, move in the desired direction.

One further refinement of the present invention provides that the motor vehicle, in an emergency operation, is only braked by the transmission device when the vehicle speed is below a threshold value. As was stated above, the transmission device is frequently braked or blocked by a braking element acting in a form-locking manner. Accordingly, in the case of braking using the transmission device, at too high a speed, damage to the transmission device is possible, particularly the shearing off of the braking element. To avoid this, the braking of the motor vehicle should be carried out, using the transmission device, only if the speed of the motor vehicle is less than the threshold value. In an especially preferred manner, the automatic guidance of the motor vehicle is only performed at a low vehicle speed, which is less than the threshold value. The threshold value is equal to the walking speed, for example. It may also be provided that the automatic guidance is not first initiated at all, or broken off, when the vehicle speed reaches or exceeds the threshold value. In addition or alternatively, it may be provided that the automatic guidance may only be initiated from the standstill of the motor vehicle. In this context, the vehicle speed is subsequently preferably determined by the automatic guidance.

Furthermore, the present invention relates to a driver assistance system for the automatic guidance, particularly parking, of a motor vehicle, preferably for carrying out the method described above, the motor vehicle having a driving device for driving the motor vehicle, braking equipment for braking the motor vehicle as well as a transmission device, and, in normal operation, automatic braking is able to be carried out during the guidance using the braking equipment. In this context, it is provided that the driver assistance system is developed so that when a fault of the braking equipment occurs during the automatic guidance, an emergency operation is carried out, in which the motor vehicle is braked automatically to a standstill only by using the driving device and/or the transmission device. The method carried out with the aid of the driver assistance system may be further developed according to the above explanations. The advantages have already been addressed.

The present invention will be described in greater detail below with the aid of the exemplary embodiments shown in the drawing, without a restriction of the invention taking place.

### BRIEF DESCRIPTION OF THE DRAWING

FIG. 1 shows a schematic representation of a motor vehicle during an automatic parking process.

### DETAILED DESCRIPTION OF THE INVENTION

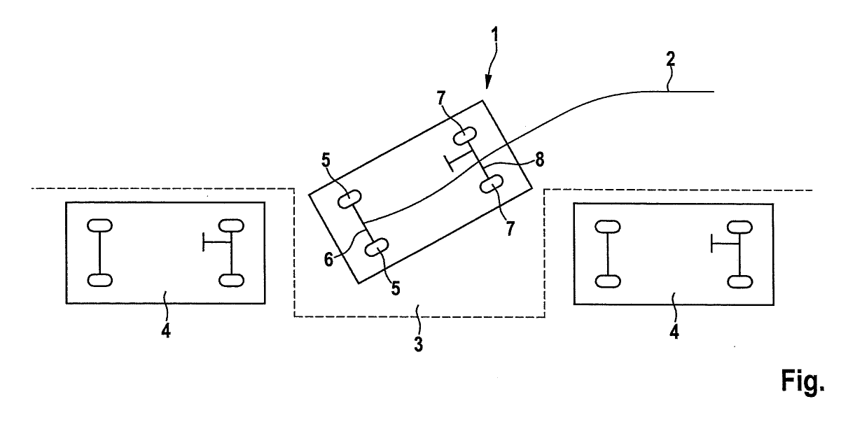

FIG. 1 shows a motor vehicle 1 during a parking process, as well as a trajectory 2 used in the process. Along trajectory 2, motor vehicle 1 gets onto a parking area 3, which in this case is present in the form of a parking space between two further motor vehicles 4. Motor vehicle 1 has two drivable wheels 5 of a rear axle 6, and two non-drivable wheels 7 of a front axle 8. Motor vehicle 1 has a driving device, by which at least wheels 5 are drivable. For this purpose, the driving device that is not shown is operatively connected, or is able to be operatively connected to wheels 5 via a transmission device and a clutch device. On the other hand, wheels 7 have a steering device assigned to them, whereby a desired steering angle is able to be set on wheels 7. The steering device in this instance is developed in such a way that the steering angle is able to be set automatically by a driver assistance system, not shown, which enables an automatic guidance or parking of motor vehicle 1. In one alternative specific embodiment, wheels 7 may also be driven with the aid of the driving device. Motor vehicle 1 also has braking equipment for braking motor vehicle 1. Usually, the braking equipment acts upon all wheels of motor vehicle, that is, both on wheels 5 of rear axle 6 and on wheels 7 of front axle 8.

The driver assistance system mentioned above is used especially for the automatic parking of the motor vehicle. For this purpose, it determines a trajectory 2, along which motor vehicle 1 is able to get onto parking area 3, taking into account adjacent obstacles, particularly other motor vehicles 4. Subsequently, the driving device and the steering device are actuated so that the motor vehicle moves along trajectory 2. During parking, or rather during the parking process of motor vehicle 1, if deceleration of motor vehicle 1 is required, particularly down to a standstill, the braking equipment is actuated accordingly. Automatic braking may be carried out correspondingly with the aid of the braking equipment. For this purpose, the braking equipment usually has an operating brake, which is present in the form of an hydraulic brake, and is operatively connected to wheels 5 and 7. After reaching a final parking position on parking area 3, motor vehicle 1 is decelerated down to a standstill with the aid of the braking equipment, particularly also the operating brake. Subsequently, motor vehicle 1 is preferably settled in place in the parking position, using a parking brake of the braking equipment.

During the parking, the braking equipment continually transmits an operating state to the driving device and/or the transmission device, with the aid of a communication device. As long as the operating state corresponds to a functioning braking equipment, a normal operation is carried out. If, on the other hand, the operating state points to a fault in the braking equipment, a change is made from normal operation to an emergency operation. In the latter case, motor vehicle 1 is automatically braked down to a standstill, using the driving device and/or the transmission device. That is, it is provided that the driving device monitors the operating state of the braking equipment. The monitoring, in this case, may include both a braking equipment control unit and the operating brake and/or the parking brake. In particular, the braking equipment control unit is developed to monitor the operating brake and the parking brake, and to transmit a fault in these devices in the form of the operating state of the driving device. If the braking equipment control unit indicates a fault in the operating brake, the method described above, for automatically braking of motor vehicle 1, is carried out. In the case of a fault in the parking brake, this is first of all not absolutely necessary, but may also be provided.

In the case of a defect in the braking equipment control unit, this is no longer able to transmit the operating state to the driving device or the transmission device. The driving device and the transmission device are therefore made in such a way that, in response to an omission of the transmission of the operating state, it detects the fault in the braking equipment and also carries out or rather initiates the emergency operation.

The braking of motor vehicle 1 now no longer takes place in the emergency operation with the aid of the braking equipment, but using the driving device or the transmission device. If the driving device is present in the form of an internal combustion engine, it is “choked” or shut down, for instance, upon the occurrence of the fault in the braking equipment. This may be done particularly by interrupting the fuel supply to the internal combustion engine or switching off the ignition. Thereafter the internal combustion engine no longer gives off any torque, but rather brings about the braking of the motor vehicle, because of its moment of inertia and/or its internal frictional forces. For this purpose, an operative connection from the driving device to wheels 5 is produced via the transmission device and the clutch device.

The braking with the aid of the transmission device takes place particularly in that an output shaft of the transmission device is braked and/or blocked in response to the occurrence of the fault. The output shaft is present on the side of the transmission device facing away from the driver information, and is operatively connected or operatively connectible to the drivable wheels 5. The transmission device usually has a drive shaft which is operatively connected directly to the driving device. The output shaft is driven by the drive shaft via a transmission ratio. The output shaft is now able to be operatively connected to wheels 5, via the clutch device. Accordingly, because of the braking or blocking of the output shaft, motor vehicle 1 is able to be decelerated.

The blocking of the output shaft is particularly provided if the transmission device is present as an automatic transmission device. In this case, a parking state is set on the transmission device, in which braking means cooperate in a form-locking manner with the output shaft for its blocking. Accordingly, it is advantageous if the braking using the transmission device is carried out only if the vehicle speed is below a certain threshold value. At too great a vehicle speed, the braking means and/or the output shaft may be damaged.

In addition or alternatively, it may also be provided that braking the motor vehicle using the driving device or the transmission device is not carried out upon the exceeding of a certain angle of inclination of the motor vehicle, because in this case the moment of inertia and/or the internal frictional forces of the driving device are not sufficient to bring motor vehicle 1 to a standstill. In a particularly preferred manner, in this case, the automatic guidance or parking of motor vehicle 1 is not even initiated at all. The angle of inclination of motor vehicle 1 may be determined, for instance, with the aid of an inclination sensor.

The braking equipment is actuated for the automatic braking of a control unit of a driver assistance system, for example, particularly an ESP driver assistance system. The braking equipment is particularly a component of the driver assistance system. In response to a fault of the braking equipment control unit, there now takes place a degradation of the functionality. Accordingly, no automatic deceleration is possible with the aid of the operating brake. In this case, the nonavailability of the ESP functionality is usually signaled by a warning lamp to the driver of the motor vehicle. However, because the method described above is preferably used when the driver is located outside the motor vehicle, he is not able to detect the signal and accordingly cannot react to it, for example, by manually operating the braking equipment. Accordingly, motor vehicle 1 has to be braked automatically, preferably immediately down to a standstill, and the automatic parking has to be broken off. After that, the driver is able to undertake the parking manually. A manual operation of the braking equipment usually continues to be possible, even upon the occurrence of a fault in the braking equipment. The fault is preferably indicated to the driver of the motor vehicle by suitable signal means. For example, a warning blinking system is activated.

To be sure, the above statements basically relate to automatic parking. However, they are generally analogously applicable to automatic guidance of motor vehicle 1 in general form. The driver is preferably not located in motor vehicle 1 during the automatic guidance.

1-10. (canceled)

11. A method for automatic guidance of a motor vehicle during parking, the motor vehicle having a driving device, a braking equipment, and a transmission device, the method comprising:
in a normal operation of the motor vehicle, performing by the braking equipment an automatic braking during the automatic guidance of the motor vehicle during parking; and
in response to an occurrence of a fault in the braking equipment during the automatic guidance of the motor vehicle during parking, performing an emergency operation in which the motor vehicle is automatically braked to a standstill only using at least one of the driving device and the transmission device.

12. The method as recited in claim 11, wherein, in the normal operation, the braking equipment automatically brakes the motor vehicle during the automatic guidance of the motor vehicle during parking using at least one of an operating brake and a parking brake.

13. The method as recited in claim 12, wherein the driving device is an internal combustion engine.

14. The method as recited in claim 13, wherein for braking the motor vehicle in the emergency operation, at least one of a fuel supply and an ignition of the internal combustion engine is switched off.

15. The method as recited in claim 12, wherein an output shaft of the transmission device is at least one of braked and blocked in response to the occurrence of the fault in the braking equipment.

16. The method as recited in claim 12, wherein a driving device control unit of the driving device monitors the operating state of the braking equipment.

17. The method as recited in claim 16, wherein during the automatic guidance of the motor vehicle, the braking equipment transmits the operating state of the braking equipment to at least one of the driving device and the transmission device using a communication device.

18. The method as recited in claim 17, wherein during the automatic guidance of the motor vehicle, a steering angle is automatically set using a steering device.

19. The method as recited in claim 15, wherein the motor vehicle, in the emergency operation, is only braked by the transmission device if the vehicle speed is below a threshold value.

20. A driver assistance system for automatic guidance of a motor vehicle during parking, the motor vehicle having a driving device for driving the motor vehicle, a brake for braking the motor vehicle, and a transmission device, the driver assistance system comprising:
a control unit including a processor and configured to control the following:
in a normal operation of the motor vehicle, performing by the braking equipment an automatic braking during the automatic guidance of the motor vehicle during parking; and
in response to an occurrence of a fault in the braking equipment during the automatic guidance of the motor vehicle during parking, performing an emergency operation in which the motor vehicle is automatically braked to a standstill only using at least one of the driving device and the transmission device.
